(19) United States
(12) Patent Application Publication
(10) Pub. No.: US 2005/0012414 A1
(43) Pub. Date: Jan. 20, 2005

(54) Method and apparatus for isolated transformation of a first voltage into a second voltage for measurement of electrical bioimpedances or bioconductances

(75) Inventor: Eberhard Gersing, Coettlngen (DE)

Correspondence Address: MARTIN & FERRARO, LLP, 1557 LAKE O'PINES STREET, NE, HARTVILLE, OH, 44632, US

(73) Assignee: Osypka Medical GmbH

(21) Appl. No.: 10/893,176

(22) Filed: Jul. 16, 2004

(30) Foreign Application Priority Data
Jul. 18, 2003 (DE) 103 32 820.3

(51) Int. Cl. H02K 7/00

(52) U.S. Cl. 310/79

(57) ABSTRACT

An apparatus for isolated transformation of a first voltage into a second voltage includes a motor (15), which is powered by the first voltage and whereof the motor drives a generator (16) utilizing a coupling means, for example, a shaft (17) or a belt drive, whereof the rotation of the shaft generates the second voltage off the generator (16). At least a portion (18) of the coupling means, for example, the shaft (17), is made of an electrically isolating material featuring a dielectric constant of approximately 1 and is of such a dimension that the capacitance of the generator related to Ground is at maximum 10 pF, preferably 5 pF. The apparatus is in particular suited to provide a voltage for supply of electronic measurement devices, which are used for impedance measurements at the human body because the apparatus meets requirements for medical safety, keeps the electrical capacitance of the measurement circuit powered by the generator at a minimum, does not transform disturbances present at the first voltage to the measurement circuitry, and doesn't generate disturbances by itself.

### BACKGROUND OF THE INVENTION

The present application claims priority to German Application No. 103 32 820.3, filed Jul. 18, 2003.

### FIELD OF THE INVENTION

The invention is related to a method and an apparatus for isolated transformation of a first voltage into a second voltage, which, in general, is used as a power supply for measurement devices of floating type, i.e., with no common ground between the first and the second voltage, for example, in biomedical applications, and in particular in the context with the measurement of electrical impedances and admittances, especially of the human body.

The measurement of electrical impedance or admittance of biological tissue, for instance, the human body, allows characterization of its state, assuming the application of appropriate frequencies. For example, measurement of electrical impedance on cardiac patients during the course of heart surgery or postopera-tively may lead to information valuable for diagnosis. This is also valid during organ transplantation for the determination of ischemia-related damage and/or recovery of the transplanted organ.

Devices intended for electrical measurements at human organs in vivo are subjected to strict safety regulations. In particular, the patient leakage current is limited to 10 μA, and the insulation between mains, to which the measurement devices are connected, and the measured human subject withstands voltages of up to 4 kV_{eff}.

Because mains, which provides most if not all of the energy required for the measurement devices, features an output voltage which needs to be transformed into one or more appropriate voltages anyway, the transformation of the first voltage into the second voltage may be combined with the insulation.

In addition to the insulation separating the first voltage and the second voltage, further requirements exist for the power supply of an impedance measurement device (FIG. 1). An output circuitry 3 of a preferred embodiment 1 with its connections 7, 8 must feature an as small as possible electrical capacitance 9 related to the input circuitry 2, which is connected to mains via connections 5, 6, and an as small as possible capacitance 11 related to ground. Small as possible capacitances 9, 11 ensure that the measurement device when operating at higher frequencies is not connected to ground and, therefore, the patient auxiliary currents, in particular those of higher frequencies, which are applied to the human body, do not leak through the body to ground but are seized completely by the measurement device. Furthermore, no high frequency disturbances, in particular radio frequency interferences, shall be conducted from the mains via the insulation to the output circuitry 3.

Common power supplies use transformers according to FIG. 2. The aforementioned requirements regarding medical safety are strict, and it has been proven challenging to limit leakage currents and, in particular, displacement currents caused by the capacitances 9a, 9b of the coils 12, 13 to less than 10 μA. Grounding of the transformer core 14 and special setup of the coils can achieve a low capacitance between primary coil and secondary coil but increases the capacitances 11a, 11b between secondary coil and Ground. A closed current loop is established, for example, in the event the patient, who is subjected to the impedance measurement, is connected (if only via a capacitance) to Ground, and the measurement devices are connected to mains, which is connected to Ground, too. Because of the Patient Auxiliary Currents are small in amplitude, capacitances between the primary coil and the secondary coil and between the secondary coil and Ground cause significant disturbances. So far, improvements aimed towards the suppression of patient leakage currents and reduction of capacitive coupling of the transformer. Only with great efforts the aforementioned limits for medical safety are met. At the same time, the performance requirement for a small capacitance of the secondary coil towards Ground is neglected.

Description of the Prior Art

WO 00/01301 A1, which is incorporated by reference, teaches an apparatus for the measurement of the impedance and the DC resistance of the skin. The power supply of the apparatus is accomplished via a transformer connected to mains. The electronic circuits for the impedance measurement are supplied via an additional DC/DC converter. The electronically generated alternating measurement voltage is applied via a transformer (either directly or after rectification) to electrodes, which are in contact with the skin. The resulting current through the measurement circuitry causes a voltage drop across a resistor, which is amplified, rectified and measured employing an ADC, however, not by a current—likewise the impedance measurement—but by an alternating voltage of a source of a small internal resistance applying a transformer.

The generation of direct or alternating voltages of various amplitudes, shapes, frequencies and/or modulation applying a motor-generator-system, in particular for therapeutic use, is known (U.S. Pat. No. 1,908,688, which is incorporated by reference). The generated voltage is directly applied to electrodes on the human body. Despite galvanic insulation between the output of the apparatus and the input (mains) via inductive coupling, the nowadays required dielectric strength of 4 kV_{eff} is, practically, difficult to achieve, and even less a low electrical capacitance between input circuitry and output circuitry. Like the previous apparatus intended for the generation of insulated measurement signals, this apparatus is not suitable for use as a power supply for medical device applications.

### SUMMARY OF THE INVENTION

Purpose of the invention is to provide a means for a transformation of a first voltage at the input, which is related to Ground, into a second voltage at the output,
a) whereof the source of the second voltage has a capacitance related to Ground which is as low as possible;
b) whereof noise signals present at the input are not transformed to the output; and
c) whereof the means itself does not generate any additional noise.

Commonly available DC/DC or AC/DC converters do not meet particularly the last requirement. In fact, these converters exhibit common mode disturbances at the output and significant magnetic stray fields of high frequency, which may cause disturbances to sensitive circuitry of a measurement unit. Principally, common mode disturbances can be reduced by a capacitor of appropriate capacitance (and dielectric strength), which connects the input and the output. This fix, however, is contrary to the requirement for the capacitance between input and output 9 (FIG. 1) being as low as possible.

The means for transformation shall be accomplished by a simple design and reasonable costs and, at the same time, meet the requirements for medical safety, for instance, that the patient leakage current at the output is less than 10 μA and that the insulation withstands up to 4 kV_{eff}.

The preferred embodiment described in the first claim accomplishes aforementioned purpose and requirements according to the invention. Other embodiments are provided within the other claims.

The invention incorporates that at least a portion of a coupling means between a motor and a generator is manufactured of an electrically insulating material with a dielectric constant close to 1 but always less than 2. Generally, the coupling means is a shaft or a portion of a shaft, or the motor or generator shaft, or the belt of a belt drive or a shaft coupling, for instance, an elastic coupling. The generator's capacity against Ground shall be less than 10 pF, preferably, 8 pF or, in particular, 5 pF.

Generally, the second voltage is a low voltage for supply of electronic circuits of a measurement device.

With regards to the claims, each partial axial unit of a shaft is referred to as a portion of the shaft. For instance, if a shaft is a cylindrical rod with constant diameter, then the portion of the shaft is a cylinder of the same diameter but less in length compared to the rod. A portion of a cylinder, which is in diameter less than the shaft but is not manufactured of an isolating material, is not referred to as a portion of the shaft.

Because of the electrically isolating portion of the shaft, or the incorporation of a particular connection shaft made of electrically isolating material with a dielectric constant close to 1, a high voltage isolating barrier between motor and generator is achieved, which avoids leakage currents flowing form the motor towards the generator or vice versa. Furthermore, a sufficient spatial distance between motor and generator keeps the capacitive coupling in between at an appropriate low level.

Although the description refers generally to a single shaft, the scope of the invention includes an embodiment which uses a separate shaft for connecting the motor shaft with the generator shaft, whereof the separate shaft is manufactured of an isolating material and represents the electrically isolating portion of the shaft. For instance, an electrically isolating portion of the shaft is flanged onto the ends of the motor and generator shaft, respectively. Another possibility is to use a connecting tube, which is made of electrically isolating material of a dielectric constant close to 1 and pulled over the shaft of the motor and the shaft of generator in such a way that the torque is transferred through the tube. Another embodiment accomplishes the mechanical coupling by use of a belt drive, which includes two pulleys mounted on the respective shafts of motor and generator, and a belt made of electrically isolating material rotating on these pulleys. In addition, the pulleys may be manufactured of electrically isolating material with a lowest dielectric constant in order to reduce the electrical capacitance.

Preferably, the electrically isolating material is a plastic material, for instance, Nylon, Trovidur® (brand name) or Polystyrol. Ceramic material, such as Degussit® (brand name), may be used instead.

According to the invention, the motor is operated of an energy or voltage supply (the first voltage). The rotation of its shaft is electrically isolated transferred to the shaft of the generator. The generator generates the second voltage. The second voltage may be used to supply electronic measurement circuitry, which is connected via electrical connections to the human body, which is subjected to bioimpedance or bioadmittance measurements.

An alternating current (AC) motor serves as the motor. Alternatively, a direct current (DC) motor is used, incorporating a collector or electronic commutation, which is operated utilizing a rectifier or a battery. For example, the battery can be a commonly available car battery. Note: In the event this battery is connected directly to the measurement circuitry, impedance measurements at the human body would be subjected to errors, in particular at higher frequencies, because the battery is capacitively coupled to Ground.

The motor must not necessarily be of type electric motor. For instance, a particular case may require a motor operated by pressurized air (turbine).

In the embodiment whereof the first voltage is the voltage provided by mains and the second voltage a DC voltage, the means according to the invention is a particular form of a power supply.

The combination of a motor and a generator according to the invention is known, in particular, as a rotating converter or motor-generator. In addition to the new aspect according to the invention that a portion of the shaft is made of electrically isolating material with a very low dielectric constant, the rotating converters commonly known are utilized in applications dealing with voltages and, in particular, power, of a different scale, such as in transformer stations. The apparatus according to the invention usually is intended for a first voltage, i.e., the alternating voltage provided by mains, of 230 V or 110 V or 100 V or a battery output of 12 V or 24 V. Usually, the second voltage is in the range of 5 V to 15 V DC or AC voltage. The apparatus according to the invention is significantly smaller than commonly known power converters because only small electrical power must be provided for the measurement circuitries. For a power supply of 50 W the longest width of the motor-generator system, for instance, measures 20 cm at a diameter of 4 cm or significantly less, depending on the output power required.

The shaft, or the connecting shaft, should not be too short in length in order to keep the capacitance between the metallic parts of the input circuitry and output circuitry of less than 5 pF. The uncovered portion of the shaft, i.e., the portion of the shaft which extends the drive of the motor but is not inside the stator of the generator, that is, outside the motor and outside of the generator, should be minimum as long as the length of the motor or generator, for instance, 5-10 cm.

A long shaft, however, makes only sense if the electrically isolating portion of it is as long as possible. In the preferred embodiment, the electrically isolating portion of the shaft is as long as the portion of the shaft outside of motor and generator.

Because the apparatus according to the invention is used within a room where patients are diagnosed or treated, it is advantageous if the apparatus operates as quietly as possible. The rotation movement may cause a humming noise. Preferably, the apparatus, which is, as previously described, small in size, is embedded into a sound-proof enclosure, i.e., an enclosure which is as much as sound proof as possible. The apparatus may be incorporated into the same measurement device it is supplying power for.

The apparatus according to the invention is characterized of
a strong isolation of electrical potentials and a high resistance across the isolation between input and output circuitry,
a low electrical capacitance of the output circuitry against Ground,
suppression of disturbances present at the input,
prevention of high-frequency disturbances generated by the apparatus itself,
bridging of brief temporary power failures, in particular by use of a flywheel.

Thus, the apparatus according to the invention is not limited as a power supply for measurement devices in medical applications but related areas in biotechnology and pharmaceutical technology.

Further advantages of the invention are demonstrated in the following description of preferred embodiments of the invention along with the figures.

### BRIEF DESCRIPTION OF THE DRAWINGS

FIG. 1 illustrates a known, state-of-the-art apparatus utilized as a power supply for an impedance measurement device.

FIG. 2 illustrates a known apparatus similar to FIG. 1 whereof transformers are used.

FIG. 3 illustrates a first embodiment according to the invention.

FIG. 4 illustrates a second embodiment according to the invention.

FIG. 5 illustrates a third embodiment according to the invention including its electronic components.

FIG. 6 illustrates a forth embodiment according to the invention including its electronic components.

FIG. 7 illustrates a modification of the embodiment of FIG. 6.

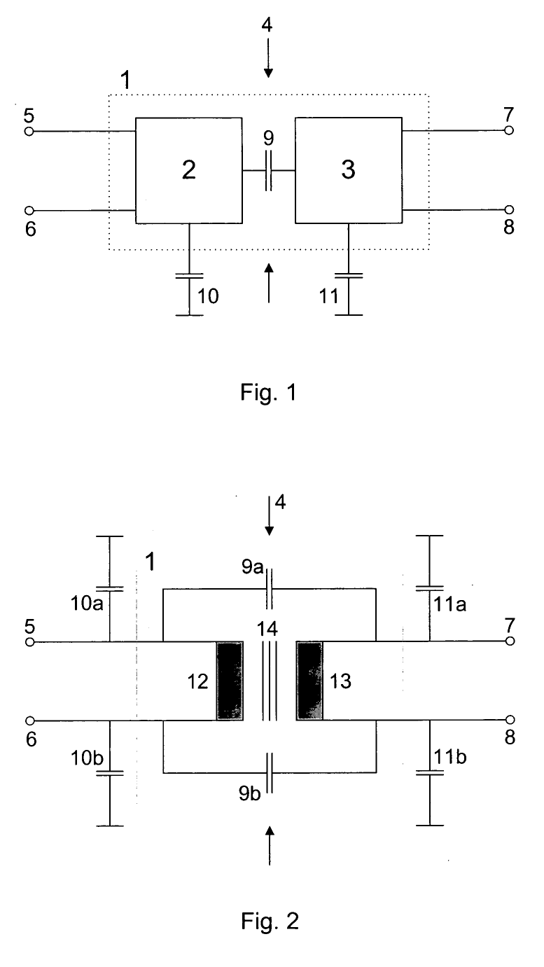

### DETAILED DESCRIPTION OF THE PREFERRED EMBODIMENT

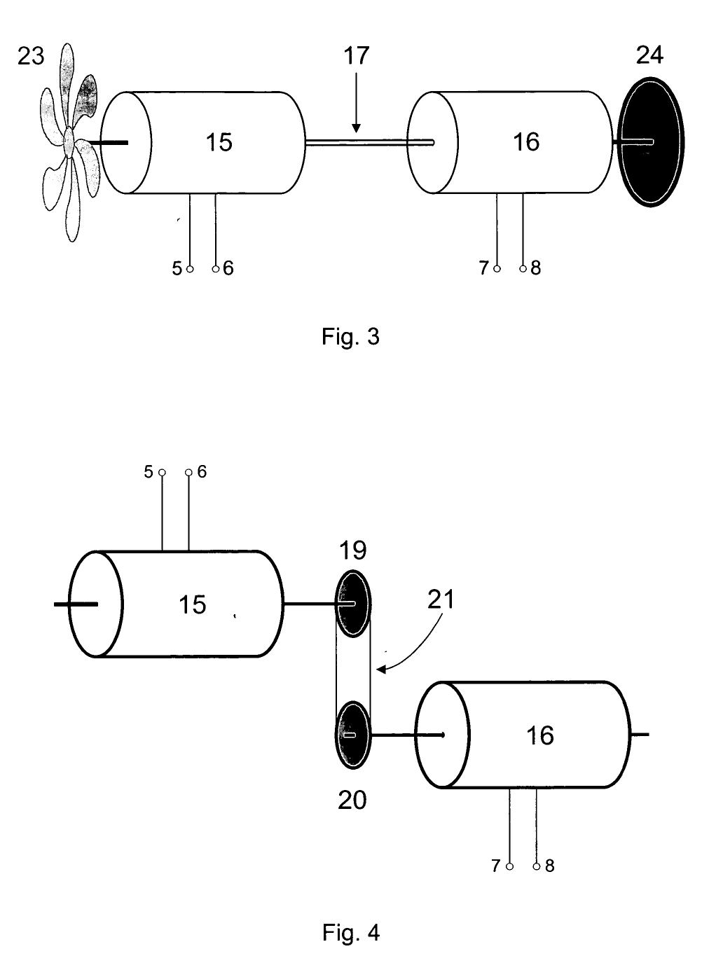

In the first embodiment of a power supply according to the invention (FIG. 3), a motor 15, which is powered by a first voltage supplied via input terminals 5 and 6, turns via a shaft 17, which is completely made from an electrically isolating material, a rotor of a generator 16, which generates a second voltage, which is provided via the output terminals 7 and 8 of the generator and available for power supply to the measurement device.

The second embodiment according to the invention (FIG. 4) utilizes a belt drive 21 between the shaft of the motor 15, which is usually made from metal, and the shaft of the generator 16, which is usually made from metal. Pulleys 19, 20, which are made from metal or an electrically non-conducting material featuring a dielectric constant close to 1 are fixed onto the end of each shaft and connected together by an isolating belt 21.

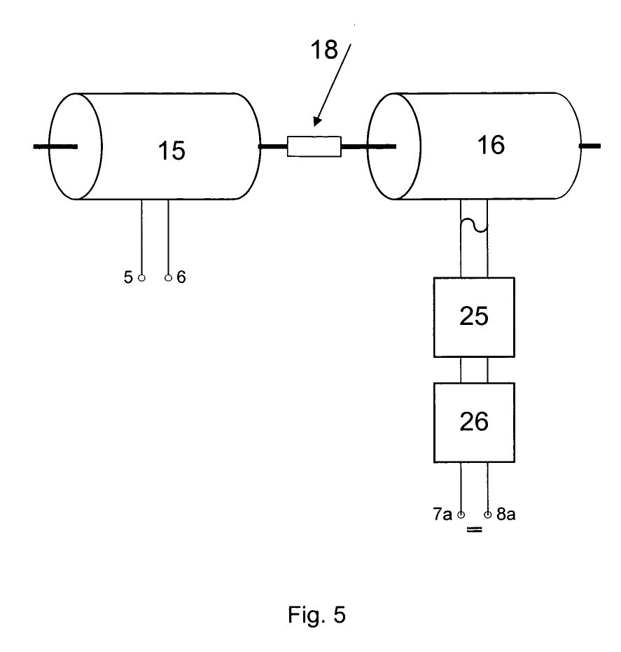

The first embodiment (FIG. 3) can be modified in such a way that not the entire shaft 17 is made from isolating material but only a portion 18 as illustrated in the third embodiment in FIG. 5. The portion of the shaft 18 is shown thickened compared to the shaft in order to emphasize on the qualitatively improved potential isolation.

FIG. 3 illustrates that a propeller 23 can be affixed upon the extended shaft as a means for forced ventilation and cooling of the apparatus itself and/or the measurement device into which the apparatus is incorporated.

Brief temporarily mains power failures (of the first voltage) can be bridged by a flywheel 24 of sufficient moment of inertia, which is fixated on the extended motor or generator shaft (FIG. 3).

Instead of an alternating voltage, the preferred embodiment (FIG. 5) provides a direct voltage at the output terminals 7a and 8a, after rectification by a rectifier 25 and a filter 26. Note that according to FIG. 3, depending on the type of generator either an alternating voltage or a direct voltage is provided at the output terminals 7 and 8.

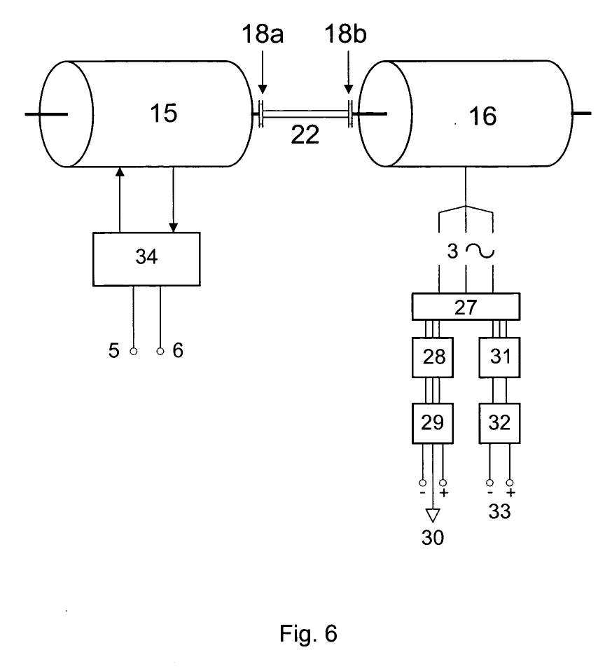

The fourth embodiment of the invention according to FIG. 6 incorporates as main components a direct voltage motor 15 (without collectors), which is, for example, powered by a car battery or, after rectification, powered by mains, and an alternating voltage generator 16. The motor 15 drives the shaft via preferably flexible coupling 18a between an intermediate shaft 22 made from electrically isolating material, which drives via a second, in particular also flexible coupling 18b, the shaft of the generator 16. Except for the intermediate shaft 22, ordinary technique is utilized. The portion of the motor shaft located within the motor 15 carries a permanent magnet as rotor. The portion of the generator shaft located within the generator 16 carries a permanent magnet, too, and rotates within a three-phase-stator.

In the embodiment according to FIG. 6 the intermediate shaft 22 can be made from electrically conducting material, for instance, metal, instead of an isolating material. Then, the flexible couplings 18a and 18b must be made from an isolating material or must isolate otherwise.

Elastic design of couplings compensate for difficult to avoid mismatches between the shafts of motor and generator. The intermediate shaft 22 is a (not necessarily) cylindrical rod, i.e., it generally has a circular cross-section.

Advantageously the isolating intermediate shaft 22 is made from Trovidur®, i.e. an electrically isolating material. Its length is approximately the same as the portions of the motor and generator shaft extended to the outside of motor and generator, respectively.

In another embodiment the couplings 18a and 18b and the isolating intermediate shaft 22 or the isolation portion 18 of the shaft 17 are replaced by an elastic tube with its ends are pulled over the shaft ends of motor and generator (FIG. 5).

FIG. 6 illustrates how the generator voltage is fed through a three-phase-transformer 27 featuring two separate secondary coils to two separate rectifiers 28 and 31 and filters and voltage stabilizers 29 and 32, whereof the terminals 30 of the voltage stabilizers 29 provide voltage outputs of +15 V and −15V (with reference to Ground), and the terminals 33 of the voltage stabilizer 32 provide a voltage output of 5 V.

The apparatus according to the invention is very small in size, for instance, for 50 Watts of power the motor has a length of 6 cm, and the diameter of the in this example cylindrical designed motor is 3.2 cm. The generator has approximately the same size. The portion of the shaft external to the motor 15 and the generator 16, which is shown uncovered (surrounded by air) in FIG. 6, has a length of approximately 10 cm. The isolating portion of the shaft has a length of approximately 5 cm.

The motor 15 (FIG. 6) can be equipped with a motor control 34, which controls the speed of the motor independent of variations of supply voltage and load.

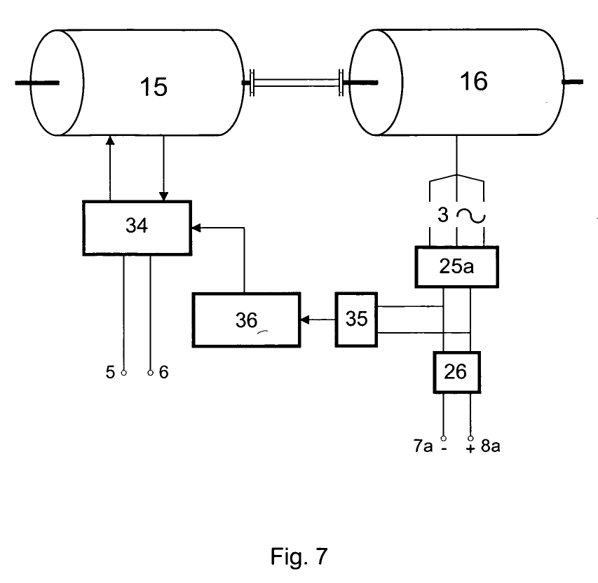

The modified embodiment according to FIG. 7 illustrates how in the event significant load variations are expected the output voltage of the rectifier 25a is measured, for example, via a linear optocoupler 35 and kept at a constant value via an additional control 36.

Furthermore, the control 36 can be designed in such away that it detects and indicates overload and, if necessary, turns off the motor 15.

Because of the small size of the components, the apparatus can be incorporated entirely into the measurement device it is supplying power for, or in a small, sound-proof enclosure which allows the dissipation of the heat generated by motor and generator but still attenuates the noise.

In order to reduce costs, it is possible to use for both motor and generator the same type of brushless motor, which principally consists of a three-phase synchronous motor with permanently magnetized rotors. The life cycle of this type of motors is limited only by its bearings.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. Apparatus for isolated transformation of a first voltage into a second voltage for measurement of electrical bioimpedances or bioconductances primarily of biological tissues, in particular of the human body, by means of an active electronic measurement device including a motor (15) operated by the first voltage, a generator (16) which is driven by the motor and which generates the second voltage independent of the Ground potential of the first voltage, and at least one coupling means between the motor and the generator made of electrically isolating material featuring a dielectric constant of approximately 1 and such a dimension that the capacitance of the generator related to Ground is not more than 10 pF, in particular 5 pF.

2. Apparatus according to claim 1 whereof the coupling means consists of at least a shaft (17, 22) or an intermediate shaft (18), whereof at least a portion of it is made of electrically isolating material.

3. Apparatus according to claim 1 whereof the coupling means is a belt drive (21) whereof the belt (24) is made of an electrically isolating material.

4. Apparatus according to one of claims 1 to 3 whereof the electrically isolating material includes a plastic material, preferably Nylon, Trovidur® or Polystyrol.

5. Apparatus according to one of claims 1 to 4, whereof the electrically isolating material includes a ceramic material, preferably Degussit®.

6. Apparatus according to claim 2, whereof the coupling means features an intermediate shaft (22) and two couplings (18a, 18b) for connection of the motor shaft (15) with the generator shaft (16), and whereof at least one of these components (18a, 18b, 22) is made of an electrically isolating material featuring a dielectric constant of approximately 1.

7. Apparatus according to claim 2 whereof the coupling means includes an intermediate shaft (22) and two couplings (18a, 18b) for connection of the motor shaft (15) with the generator shaft (16) and whereof the intermediate shaft (22) is made of electrically conducting material and at least one of the couplings (18a, 18b) is made of electrically isolating material.

8. Apparatus according to one of claims 1 to 7 whereof the first voltage is an alternating mains voltage.

9. Apparatus according to one of claims 1 to 7 whereof the first voltage is the direct voltage generated by a battery.

10. Apparatus according to one of claims 1 to 7 whereof the generator (16) incorporates a permanent magnetic rotor and a three-phase stator, which generates a three-phase alternating voltage as the second voltage.

11. Apparatus according to one of claims 1 to 9 whereof the generator (16) is a direct voltage generator.

12. Apparatus according to one of claims 1 to 8 whereof the first voltage is a alternating mains voltage and the second voltage is a direct voltage, which is independent of the Ground potential of the first voltage (input circuitry).

13. Apparatus according to one of claims 1 to 9 whereof for the single- or multiple phase alternating voltage, which is generated by the generator, a rectifier and a filter and a stabilizing means are provided, which generate a resulting voltage independent of the Ground potential of the first (input) voltage.

14. Apparatus according to one of claims 1 to 9 whereof a transformer is applied after the generator for a voltage adjustment or for a provision of multiple, different and independent voltages.

15. Apparatus according to the aforementioned claims whereof a motor control (34) is provided in order to keep the speed of the motor (15) constant.

16. Apparatus according to claim 13, which includes a control (36) in order to keep the output voltage of the rectifier (25a) at a constant level.

17. Apparatus according to claim 16, which includes a potential-isolating element (35) between the output of the rectifier (25a) and the input of the control (36).

18. Apparatus according to claim 17 whereof an optocoupler (35) is the potential-isolating element.

19. Apparatus according to one of the aforementioned claims whereof the largest dimension of the motor (15) is 20 cm, preferably 10 cm, and/or the largest dimension of the generator (16) is 20 cm, preferably 10 cm, and/or the shaft extended of the motor (15) and the generator (16) is 10 cm, preferably 5 cm, or more advantageously 3 cm.

20. Apparatus according to claim 2 whereof the portion of the shaft (18) made of isolating material is approximately as long as the portion of the shaft external to the motor (15) and the generator (16).

21. Apparatus according to one of the aforementioned claims whereof the motor-generator incorporates a propeller (23) which is mounted preferably onto the motor shaft.

22. Apparatus according to one of the aforementioned claims whereof the motor or the generator has attached a flywheel for energy storage in order to bridge power failures.

23. Apparatus according to one of the aforementioned claims, which is incorporated into a soundproof enclosure.

24. Apparatus according to one of the aforementioned claims, which is integrated into an enclosure of a measurement device to which the apparatus is supplying power.
